(19) United States
(12) Patent Application Publication
(10) Pub. No.: US 2026/0302102 A1
(43) Pub. Date: Oct. 1, 2026

(54) KEYBOARD

(71) Applicant: SUNREX TECHNOLOGY CORP., Taichung City (TW)

(72) Inventors: Yin CHU, Chongqing City (CN); Bao-Song MA, Chongqing City (CN); Shih-Pin LIN, Taichung City (TW)

(21) Appl. No.: 19/259,474

(22) Filed: Jul. 3, 2025

(30) Foreign Application Priority Data
Mar. 25, 2025 (TW) 114111206

(51) Int. Cl. H01H 13/704; H01H 13/83

(52) U.S. Cl. CPC H01H 13/704; H01H 13/83; H01H 2221/066

(57) ABSTRACT

A keyboard includes a magnetic plate, a circuit board disposed on the magnetic plate, and keys disposed on the circuit board. The circuit board includes triggers respectively corresponding to the keys. Each key includes a keycap, a metal plate, a scissor switch and an elastic component. The metal plate is disposed below the keycap and is attracted by the magnetic plate. The metal plate has a through hole and positioning pins extending into the circuit board. The scissor switch is disposed between the keycap and the metal plate. The elastic component is disposed on the metal plate and extends into the scissor switch. When one key is pressed, the keycap is brought to drive the scissor switch, and to push the elastic component such that a part of the elastic component extends through the through hole of the metal plate to press the respective one of the triggers.

### CROSS-REFERENCE TO RELATED APPLICATION

This application claims priority to Taiwanese Invention Patent Application No. 114111206, filed on Mar. 25, 2025, the entire disclosure of which is incorporated by reference herein.

### FIELD

The disclosure relates to a keyboard, and more particularly to a keyboard including easily removable keys.

### BACKGROUND

A conventional keyboard includes a case, a circuit board disposed in the case, and multiple keys disposed on the case. The case includes multiple supports which extend upward, which correspond respectively to the keys, and each of which is formed with a through hole. The circuit board includes multiple triggers which correspond respectively to the keys, and which are respectively aligned with the through holes respectively of the supports. Each of the keys includes a pin extending downward into one of the through holes. When one of the keys is pressed, the pin of the one of the keys would press the respective trigger.

To ensure structural stability of each of the keys, the conventional keyboard further includes, for each of the keys, a tight elastic component disposed on the respective one of the supports, wherein the pin of the key extends through the tight elastic component into the through hole of the respective one of the supports. However, the tight elastic component may cause trouble separating the key from the conventional keyboard since extremely great force is required for separation. Besides, exerting extremely great force may cause occurrence of accidental injury to a user.

### SUMMARY

Therefore, an object of the disclosure is to provide a keyboard that can alleviate at least one of the drawbacks of the prior art.

According to the disclosure, the keyboard includes a magnetic plate, a circuit board and multiple keys.

The magnetic plate is for producing a magnetic field.

The circuit board includes a board body and multiple triggers. The board body is disposed on the magnetic plate along an up-down direction. The board body has multiple key regions. Each of the key regions is formed with multiple positioning holes. The triggers are disposed respectively on the key regions of the board body.

The keys are disposed respectively at the key regions of the board body along the up-down direction and correspond respectively to the triggers. Each of the keys includes a keycap, a metal plate, a scissor switch and an elastic component. The metal plate is disposed below the keycap along the up-down direction, and is attracted by the magnetic plate along the up-down direction under the magnetic field so as to be removably attached to the respective one of the key regions of the board body. The metal plate has a plate body that is formed with a through hole aligned with the respective one of the triggers. The metal plate has multiple positioning pins that extend downward from the plate body opposite to the keycap respectively into the positioning holes at the respective one of the key regions of the board body. The scissor switch is disposed between the keycap and the metal plate. The elastic component is disposed on the metal plate and extends into the scissor switch.

When one of the keys is pressed, the keycap of the one of the keys is brought to drive the scissor switch of the one of the keys, and to push the elastic component of the one of the keys downward such that a part of the elastic component extends through the through hole of the metal plate of the one of the keys to press the respective one of the triggers.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a keyboard according to an embodiment of the disclosure.

FIG. 2 is a partly exploded perspective view illustrating the keyboard according to the embodiment of the disclosure.

FIG. 3 is a fragmentary partly exploded perspective view illustrating six keys being separated from a circuit board of the keyboard according to the embodiment of the disclosure.

FIG. 4 is an exploded perspective view illustrating one key of the keyboard according to the embodiment of the disclosure.

FIG. 5 is an exploded perspective view illustrating a metal plate and an elastic component of one key of the keyboard according to the embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

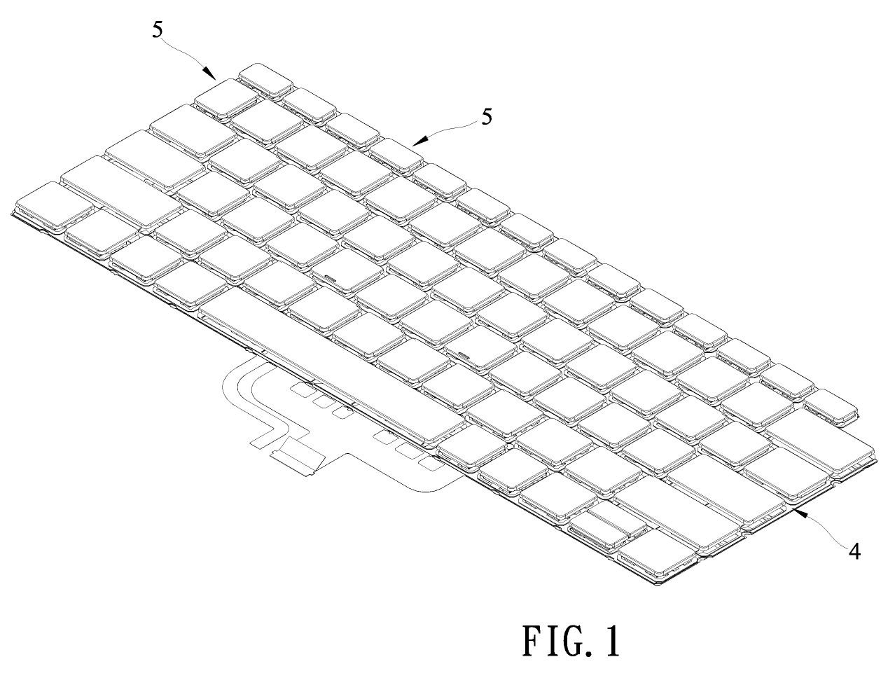

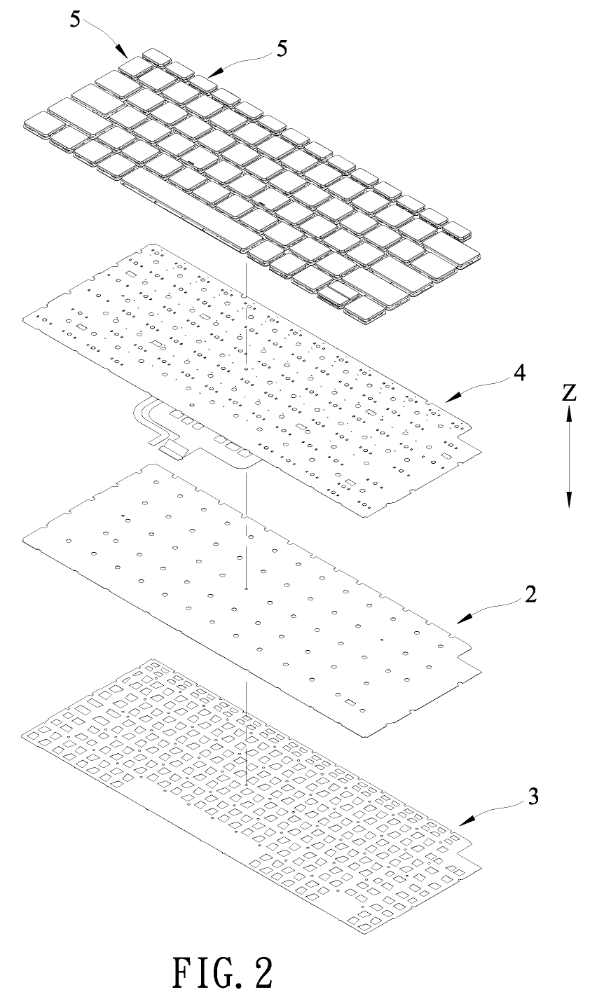

Referring to FIGS. 1 and 2, an embodiment of a keyboard according to the disclosure is illustrated. The keyboard includes a magnetic plate 2, a baseboard 3, a circuit board 4 and multiple keys 5.

The magnetic plate 2 is for producing a magnetic field.

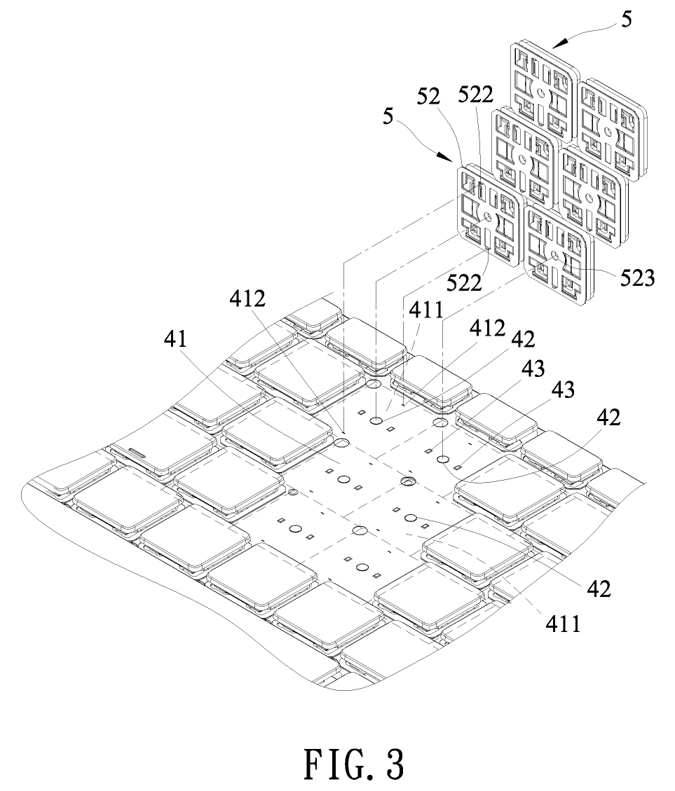

Referring to FIGS. 2 and 3, the circuit board 4 includes a board body 41 and multiple triggers 42. The board body 41 of the circuit board 4 is a flexible printed circuit (FPC). The board body 41 is disposed on the magnetic plate 2 along an up-down direction (Z). The board body 41 has multiple key regions 411. Each of the key regions 411 is formed with multiple positioning holes 412. In this embodiment, each of the key regions 411 is formed with two positioning holes 412, but is not limited thereto. The triggers 42 are disposed respectively on the key regions 411 of the board body 41. Each of the triggers 42 is configured to generate and output a trigger signal when the trigger 42 is pressed. Since implementation of the triggers 42 has been well known to one skilled in the relevant art, detailed explanation of the same is omitted herein for the sake of brevity. In some embodiments, the circuit board 4 further includes multiple lighting components 43 that are disposed on the board body 41 of the circuit board 4, wherein for each of the key regions 411, two of the lighting components 43 are disposed at the key region 411 (that is, each of the key regions 411 accommodates two lighting components 43). Each of the lighting components 43 may be implemented to be a light-emitting diode (LED), but is not limited thereto.

The baseboard 3 is disposed below the magnetic plate 2 along the up-down direction (Z) opposite to the circuit board 4.

The keys 5 are disposed respectively at the key regions 411 of the board body 41 along the up-down direction (Z) and correspond respectively to the triggers 42. As a result, a number of the keys 5 is identical to a number of the triggers 42, and is also identical to a number of the key regions 411 of the board body 41.

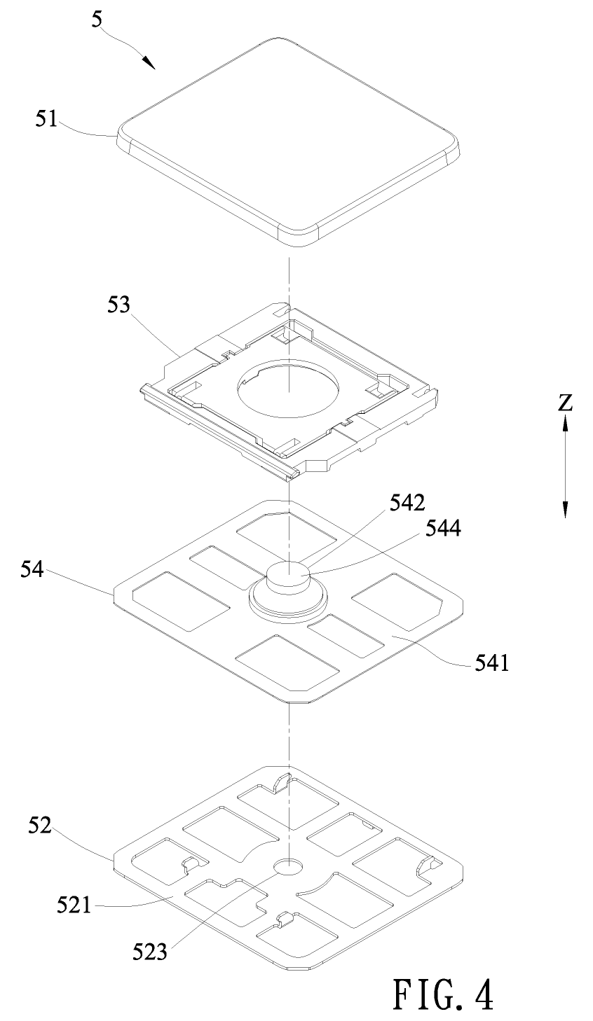

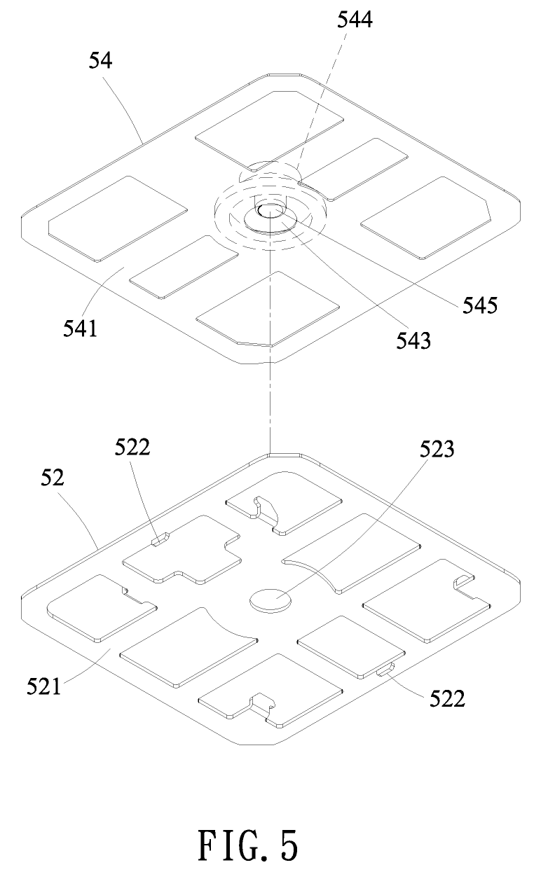

Referring to FIGS. 3, 4 and 5, each of the keys 5 includes a keycap 51, a metal plate 52, a scissor switch 53 and an elastic component 54. The metal plate 52 of each of the keys 5 is made of iron. The metal plate 52 is disposed below the keycap 51 along the up-down direction (Z). The metal plate 52 is attracted by the magnetic plate 2 along the up-down direction (Z) under the magnetic field so as to be removably attached to the respective one of the key regions 411 of the board body 41. Consequently, each of the keys 5 is removably attached to the respective one of the key regions 411 of the board body 41 under the magnetic field. Referring to FIG. 5, for each of the keys 5, the metal plate 52 has a plate body 521 that is formed with a through hole 523 aligned with the respective one of the triggers 42, and the metal plate 52 further has multiple positioning pins 522 that extend downward from the plate body 521 opposite to the keycap 51 respectively into the positioning holes 412 that are formed at one of the key regions 411 at which the key 5 is disposed. In this embodiment, the metal plate 52 has two positioning pins 522, but is not limited thereto. The scissor switch 53 is disposed between the keycap 51 and the metal plate 52. Since the scissor switch 53 has been well known to one skilled in the relevant art, detailed explanation of the same is omitted herein for the sake of brevity. The elastic component 54 is exemplarily a rubber dome, but is not limited thereto. The elastic component 54 is disposed on the metal plate 52 and extends into the scissor switch 53. When one of the keys 5 is pressed, the keycap 51 of the one of the keys 5 is brought to drive the scissor switch 53, and to push the elastic component 54 of the one of the keys 5 downward such that a part of the elastic component 54 of the one of the keys 5 extends through the through hole 523 of the metal plate 52 of the one of the keys 5 to press the respective one of the triggers 42.

Specifically, for each of the keys 5, the elastic component 54 includes a thin film 541 and an elastic body 542. The thin film 541 is disposed on the plate body 521 of the metal plate 52 and is formed with a through hole 543. The elastic body 542 is disposed on the thin film 541 and extends into the scissor switch 53 toward the keycap 51. The elastic body 542 includes an upper contact portion 544 and a lower contact portion 545. The upper contact portion 544 is disposed on the thin film 541 and is configured to be pushed by the keycap 51 when the key 5 is pressed. The lower contact portion 545 is connected to the upper contact portion 544. The lower contact portion 545 is aligned with the through hole 543 of the thin film 541. The lower contact portion 545 extends downward from the upper contact portion 544 along the up-down direction (Z). The lower contact portion 545 is configured to be driven by the upper contact portion 544 to extend through the through hole 543 of the thin film 541 and the through hole 523 of the metal plate 52 to press the respective one of the triggers 42 when the upper contact portion 544 is pushed.

It is worthy of note that when an arbitrary one of the keys 5 is to be assembled (hereinafter also referred to as the arbitrary key) to the circuit board 4, as long as the arbitrary key is in proximity to one of the key regions 411 of the board body 41, the arbitrary key would be attracted by the magnetic plate 2 under the magnetic field so as to be removably attached to the one of the key regions 411. Then, the positioning pins 522 of the arbitrary key would pass respectively through the positioning holes 412 of the one of the key regions 411, and thereby the arbitrary key would be fastened to the one of the key regions 411. Therefore, it is convenient to assemble any one of the keys 5 to the circuit board 4. On the other hand, when the arbitrary key is to be separated from the circuit board 4, only a relatively small force is required to overcome the magnetic attraction exerted by the magnetic plate 2 on the arbitrary key for separation. Thus, it is convenient to separate any one of the keys 5 from the circuit board 4 as well. Since it is convenient to assemble a key to the circuit board 4 and to separate a key from the circuit board 4, a user is able to personalize the keyboard in a casual way by replacing any one of the keys of the keyboard with another key having a different appearance from the key.

To sum up, by virtue of the magnetic plate 2, the metal plates 52 respectively of the keys 5, the positioning holes 412 of the circuit board 4 and the positioning pins 522 of the keys 5, any one of the keys 5 is removably attached to the circuit board 4 of the keyboard, and thereby can be easily assembled to the circuit board 4 or can be easily separated from the circuit board 4. Convenience of using the keyboard may be enhanced.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A keyboard comprising:
a magnetic plate for producing a magnetic field;
a circuit board including
a board body that is disposed on said magnetic plate along an up-down direction, and that has multiple key regions, each of said key regions being formed with multiple positioning holes, and
multiple triggers that are disposed respectively on said key regions of said board body; and
multiple keys disposed respectively at said key regions of said board body along the up-down direction and corresponding respectively to said triggers, each of said keys including
a keycap,
a metal plate that is disposed below said keycap along the up-down direction, and that is attracted by said magnetic plate along the up-down direction under the magnetic field so as to be removably attached to the respective one of said key regions of said board body, said metal plate having a plate body that is formed with a through hole aligned with the respective one of said triggers, and multiple positioning pins that extend downward from said plate body opposite to said keycap respectively into said positioning holes at the respective one of said key regions of said board body,
a scissor switch that is disposed between said keycap and said metal plate, and
an elastic component that is disposed on said metal plate and extends into said scissor switch,
wherein, when one of said keys is pressed, said keycap of said one of said keys is brought to drive said scissor switch of said one of said keys, and to push said elastic component of said one of said keys downward such that a part of said elastic component extends through said through hole of said metal plate of said one of said keys to press the respective one of said triggers.

2. The keyboard as claimed in claim 1, wherein said board body of said circuit board is a flexible printed circuit (FPC).

3. The keyboard as claimed in claim 1, wherein said metal plate of each of said keys is made of iron.

4. The keyboard as claimed in claim 1, wherein said circuit board further includes multiple lighting components that are disposed on said board body of said circuit board.

5. The keyboard as claimed in claim 4, wherein for each of said key regions, two of said lighting components are disposed at said key region.

6. The keyboard as claimed in claim 1, further comprising a baseboard disposed below said magnetic plate along the up-down direction opposite to said circuit board.

7. The keyboard as claimed in claim 1, wherein for each of said keys, said elastic component includes a thin film that is disposed on said metal plate and that is formed with a through hole, and an elastic body that is disposed on said thin film and that extends into said scissor switch toward said keycap, and
wherein for each of said keys, said elastic body includes
an upper contact portion disposed on said thin film and configured to be pushed by said keycap when said key is pressed, and
a lower contact portion connected to said upper contact portion, aligned with said through hole of said thin film, extending downward from said upper contact portion along the up-down direction, and configured to be driven by said upper contact portion to extend through said through hole of said thin film and said through hole of said metal plate to press the respective one of said triggers when said upper contact portion is pushed.
